(19) United States
(12) Patent Application Publication
(10) Pub. No.: US 2008/0245015 A1
(43) Pub. Date: Oct. 9, 2008

(54) Bahama-Style Shutter with Improved Strength and Fabricability

(75) Inventor: John Sweeney, Fort Pierce, FL (US)

Correspondence Address: HANSEN HUANG TECHNOLOGY LAW GROUP, LLP, 1725 EYE STREET, NW, SUITE 300, WASHINGTON, DC, 20006, US

(73) Assignee: EXTREME IMPACT SHUTTER SUPPLY INC., Sebastian, FL (US)

(21) Appl. No.: 12/139,364

(22) Filed: Jun. 13, 2008

(51) Int. Cl. E06B 7/08

(52) U.S. Cl. 52/473

(57) ABSTRACT

A Bahama-style storm shutter design with improved impact resistance includes shutter blades which span the width of the shutter, supported at each end by an end cap locked within side rails and supported in the middle by a center mullion having slots machined to approximately matching the blade cross section. The storm shutter design eliminates the need for extra structure to attach shutter blades to the side rails, thereby eliminating cost and fabrication complexity. The pass-through center mullion provides structural support to the shutter blades, enabling the use of full width shutter blades and eliminating center blade attachment structure.

### FIELD OF THE INVENTION

The present invention relates generally to storm shutters, and more particularly to Bahama-style storm shutters with improved impact resistance and fabricability. BACKGROUND

For centuries storm shutters have been used to protect windows and doors from high winds and impacts by materials propelled by storm winds. Along the Atlantic and Gulf coasts of the United States, storm shutters are particularly important to protect against hurricanes and nor'easters, and in many places are required by building codes and insurance companies. Recent hurricanes landfalls in Florida and the Gulf states have graphically demonstrated the importance of building coastal properties to withstand such storms, including providing storm shutters with sufficient mechanical strength to withstand the full force of hurricane winds. Thus, there is an urgent need for storm shutter systems with enhanced strength to withstand high winds and resist impacts from objects propelled by such winds.

### SUMMARY

The various embodiments provide Bahama-style storm shutter designs with improved impact resistance which is achieved at reduced fabrication cost and complexity. Shutter blades span the full width of the shutter, supported at each end by an end cap locked within the side rails and supported in the middle by a center mullion having slots approximately matching the blade cross section. The various embodiments include structures that eliminate the need for extra structure attaching shutter blades to the side rails, thereby eliminating cost and complexity of fabricating typical of conventional storm shutter designs. The pass-through center mullion provides structural support to the shutter blades, enabling the use of full width shutter blades and eliminating blade attachments typical required in conventional storm shutter designs.

### BRIEF DESCRIPTION OF THE DRAWINGS

The accompanying drawings, which are incorporated herein and constitute part of this specification, illustrate exemplary embodiments of the invention. Together with the general description given above and the detailed description given below, the drawings serve to explain features of the invention.

FIG. 1 is an elevation view of a Bahama storm shutter in a closed configuration according to an embodiment.

FIG. 2 is a cross-sectional view of the Bahama storm shutter shown in FIG. 1 in a closed configuration.

FIG. 3 is a cross-sectional view of the Bahama storm shutter shown in FIG. 1 in an open configuration.

FIG. 4 is a detail view of a portion of the Bahama storm shutter shown in FIG. 1.

FIG. 5 is a cross-sectional view of a top portion of the Bahama storm shutter shown in FIG. 1.

FIG. 6 is a cross-sectional view of a bottom portion of the Bahama storm shutter shown in FIG. 1.

FIGS. 7A and 7B are cross-sectional and top views, respectively, of a shutter blade suitable for use in the embodiment shown in FIG. 1.

FIG. 8 is a cross-sectional view of a side rail suitable for use in the embodiment shown in FIG. 1.

FIG. 9A is a cross-sectional view of an end cap suitable for use in the embodiment shown in FIG. 1.

FIGS. 9B and 9C are frontal views of a left end cap and a right end cap, respectively, suitable for use in the embodiment shown in FIG. 1.

FIG. 10 is cross-sectional view of a side rail, end cap and a portion of a shutter blade in an assembled configuration suitable for use in the embodiment in FIG. 1.

FIGS. 11A and 11B are cross-sectional and frontal views, respectively, of a center mullion suitable for use in the embodiment shown in FIG. 1.

FIG. 12 is a cross-sectional view of a top rail and mail hinge suitable for use in the embodiment shown in FIG. 1.

FIG. 13 is a cross-sectional view of a female hinge suitable for use in the embodiment shown in FIG. 1.

FIG. 14 is a cross-sectional view of a bottom rail suitable for use in the embodiment shown in FIG. 1.

FIG. 15 is a side view of a locking rod suitable for use in the embodiment shown in FIG. 1.

FIGS. 16A and 16B are end and frontal views of a channel element suitable for use in the embodiment shown in FIG. 1.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims.

As used herein, the terms “about” or “approximately” for any numerical values or ranges indicates a suitable dimensional tolerance that allows the part or collection of components to function for its intended purpose as described herein. As used herein, the terms “fastener” and “mechanical fastener” are intended to encompass all known devices, methods and materials used for attaching two or more components together, including but not limited to any one or combination of the following: threaded bolts, threaded bolts with nuts, screws, pin, rivets, pop rivets, welding, nails, adhesives and equivalents thereof. Further, references herein to “fastener” are not intended to limit the scope of the invention or the claims to the type or arrangement of example fasteners illustrated in the drawings unless a particular type of fastener is specifically recited in the claims.

The various embodiments provide a Bahama-style storm shutter design which is capable of withstanding the high wind and large impact loads that may be experienced in a large hurricane. Shutter blades span essentially the entire width of the shutter, supported at each end by an end cap locked within the side rails and supported in the middle by a center mullion having slots that are machined to approximately match the cross section of shutter blades. No further support for the shutter blades is required. The various embodiments eliminate the need to connect the shutter blades to the side rails, thereby eliminating much of the cost and complexity of fabricating typical of conventional storm shutter designs. The machined pass-through center mullion provides structural support to the shutter blades, enabling the use of full width shutter blades and eliminating blade attachments typical in conventional storm shutter designs. As a consequence of the enhanced strength provided by the full-width shutter blades and center mullion, there is no need for a backing plate commonly required in conventional storm shutters, thus enabling the shutter to be see through in the open configuration while reducing weight and material costs. The innovative connection of the shutter blades to end caps coupled to the side rails without fasteners provides greater structural strength while eliminating numerous fasteners and connector rods typical in conventional shutter designs as well as obviating associated assembly steps. The Bahama-style storm shutters according to the various embodiments are easy to assemble, requiring fewer assembly steps and fastener installations. The storm shutters according to the various embodiments are also easy to deploy into the closed configuration requiring the engagement of only two locking rods which can be positioned to enable the storm shutter to be closed and locked from inside.

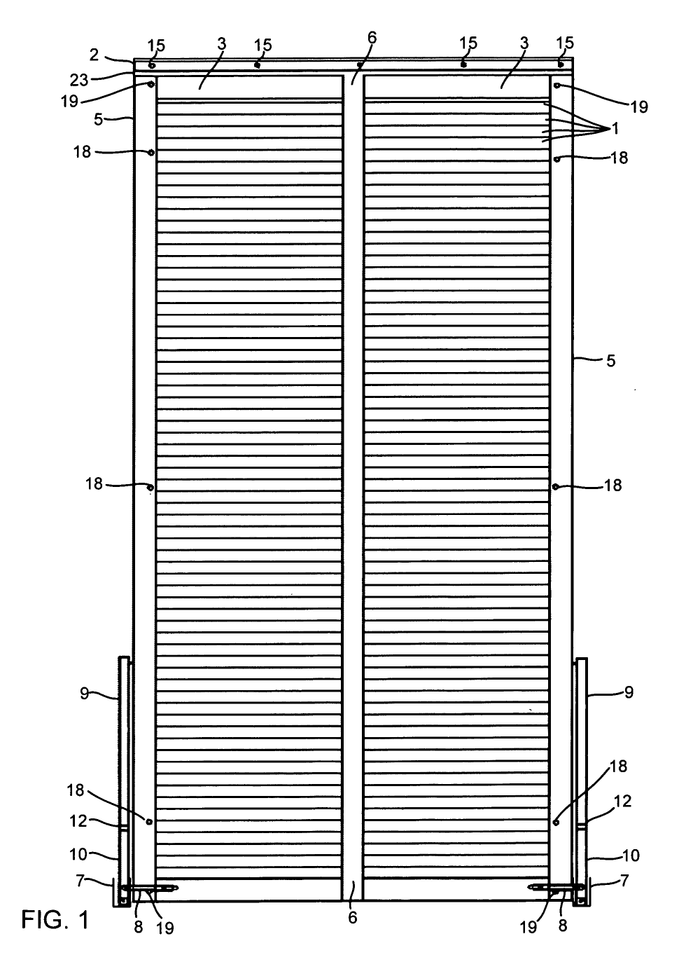

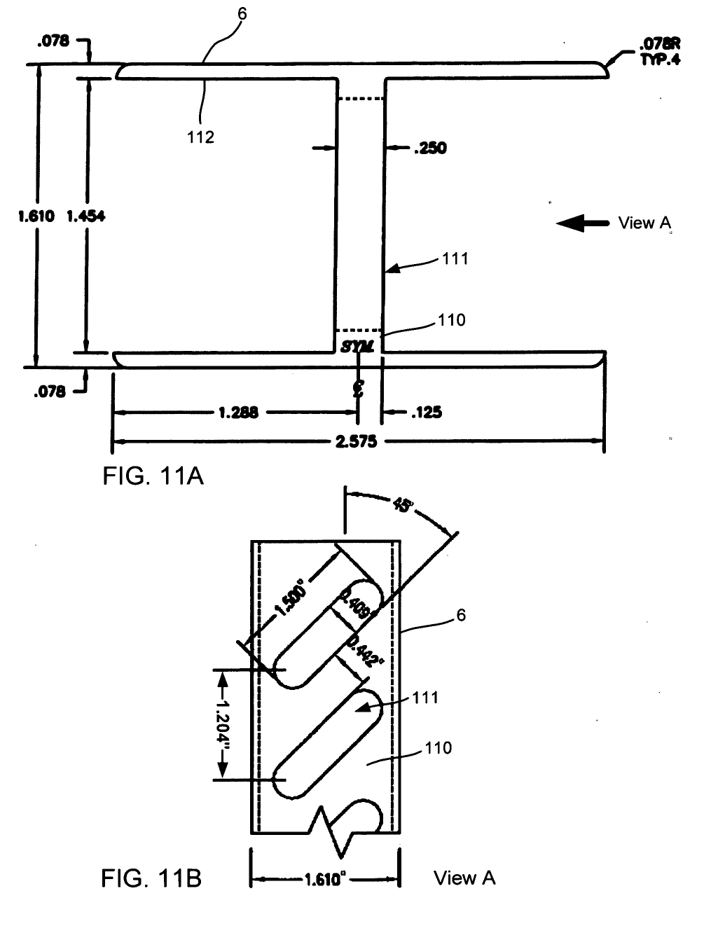

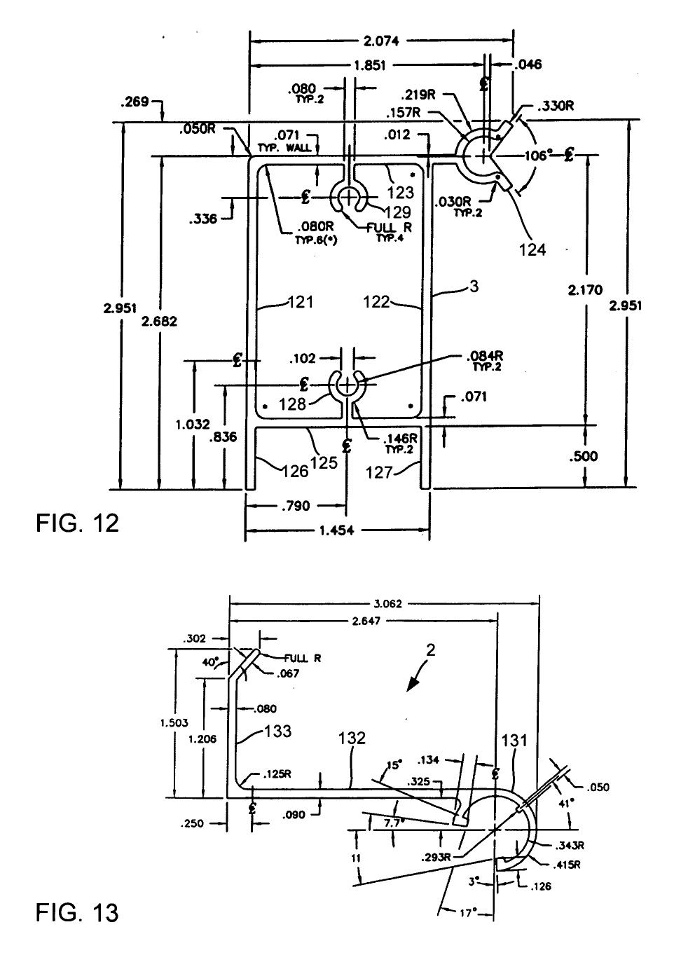

FIG. 1 provides an elevation view of an embodiment Bahama-style storm shutter assembly attached to a structure in the closed configuration. In the embodiment illustrated in FIG. 1, the storm shutter is formed from two side rails 5 joined at a top end by a top rail 3 and at a bottom end by a bottom rail 4. An end cap snaps into each of the two side rails 5 which hold in place a plurality of shutter blades 1 which span the opening between the side rails 5. A center mullion 6 extends between the top rail 3 and bottom rail 4 at or near the centerline of the storm shutter. As described in more detail below, the center mullion 6 includes machined slots (see FIGS. 11A-11B) which approximately match the cross-sectional shape of the shutter blades 1, which allow the shutter blades 1 to pass through and thus extend from one side rail 4 to the other. As described in more detail below with reference to FIGS. 8-10, the left and right end caps 13 support the shutter blades 1 within the side rails 5 without the need for additional blade fastener structures. The side rails 5 are joined to the top rail 3 and bottom rail 4 in overlapping square joints which can be secured with mechanical fasteners such as threaded fasteners. The top rail 3, which is shown in more detail in FIG. 12, includes a male hinge 124 which couples with a female hinge 2 to form a full width hinge 23. The female hinge 2 is connected, such as by lag screws or masonry fasteners 15, to a building above a window opening to enable the storm shutter to pivot outwardly from the building. A simple opening rod assembly for holding the storm shutter in the open position includes an upper serrated tube 9 which slides within a lower serrated tube 10 limited by a locking caller 12 is coupled to the lower portion of the storm shutter and to a channel 7 attached to the building. A locking rod 8 position within the bottom rail 4 on each corner can slide horizontally to engage a hole within the channel 7 in order to lock the storm shutter in the closed position.

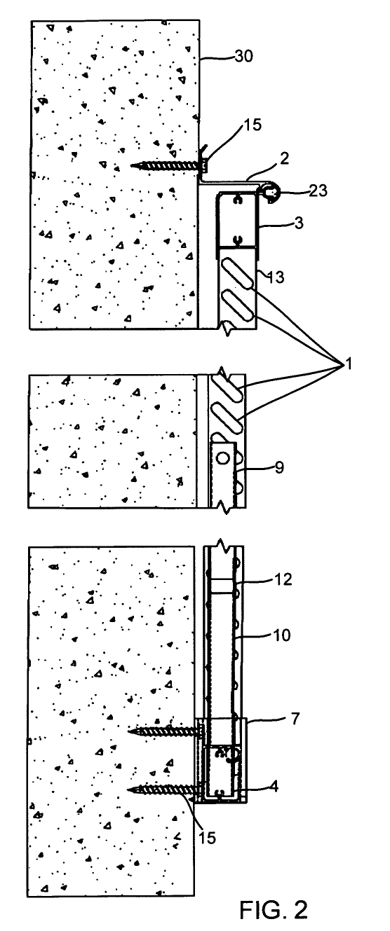

FIG. 2 shows further details of the Bahama-style storm shutter in a cross-section through the left-hand side of the storm shutter shown in FIG. 1. The storm shutter can be attached to the building by fasteners, such as lag screws 16 (see FIG. 6) for mounting the female hinge 2 on wooden frames, masonry anchors such as tapcons® 15 for mounting the female hinge 2 on masonry frames 30, or other mechanical attachments. The lag screws 16 may be driven directly into a wood window frame as illustrated on the right hand portion of FIG. 6, while tapcons® 15 may be driven directly into concrete structure 30 as illustrated in FIGS. 2, 3, 5 and the left hand portion of FIG. 6. The storm shutter hangs by the hinge joint 23 formed by the female hinge 2 and the male hinge portion 124 on the top rail 3. FIG. 2 also illustrates how, as discussed above, the shutter blades 1 are supported within slots within the end caps 13. FIG. 2 also shows the upper and lower serrated tubes 9, 10 joined by a locking collar 12, as well as the channel 7 which is attached to building structure, such as by lag screws 16 or masonry anchors such as tapcons® 15.

FIG. 2 also shows how the shutter blades 1 are canted at a 45° angle in the illustrated embodiment so that when in the closed configuration, the blades overlap thereby providing an impact resistant structure.

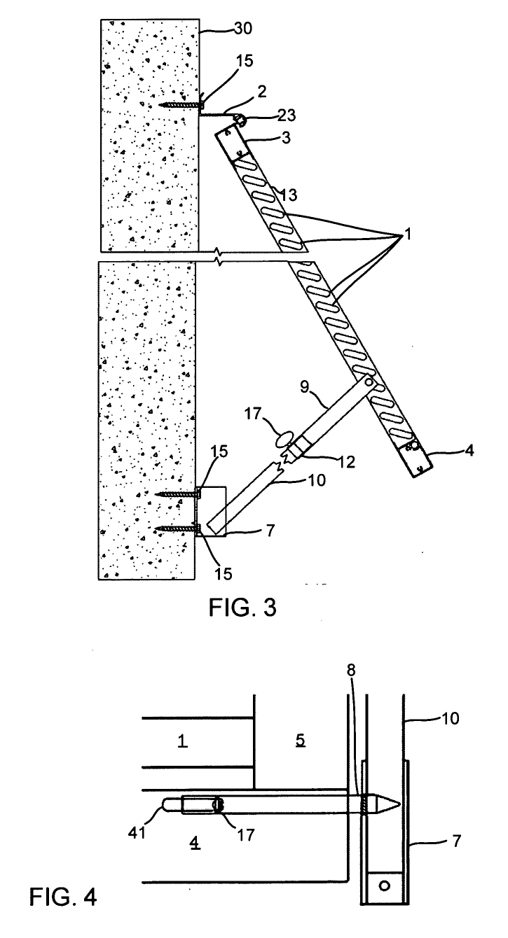

FIG. 3 shows a similar cross-sectional view of the Bahama-style storm shutter in the open configuration. This figure shows how the storm shutter pivots about the hinge joint 23 to swing outwardly from the building 30 to which it is attached. The upper serrated tube 9 extends from the lower serrated tube 10 to push the bottom portion of the storm shutter away from the building. A thumbscrew 17 in the locking collar 12 can be tightened to hold the storm shutter at a particular distance away from the building 30. FIG. 3 illustrates how canting the shutter blades 1 at a 45° angle allows light to pass between the shutter blades 1 when the shutter is in the open position.

The various embodiments can be configured and sized to fit a wide variety of building openings and be attached to a variety of building materials, including wood frames and cement block. For example, the storm shutter embodiment illustrated in FIG. 1 can be sized to fit a 50″×96″ window opening. Other size shutters can be provided by cutting the shutter blades 1, female hinge 2, top rail 3, bottom rail 4, and side rails 5 to the desired lengths. This size flexibility is achieved without the need for different components, since the shutter blades 1, female hinge 2, top rail 3, bottom rail 4, and side rails 5 are all preferably formed as extruded aluminum pieces of fixed cross-sections that can be cut to length. Thus, a single Bahama-style storm shutter design can be adapted to practically any size building opening and achieve the same level of structural integrity without the need for a plurality of different components or installation configurations.

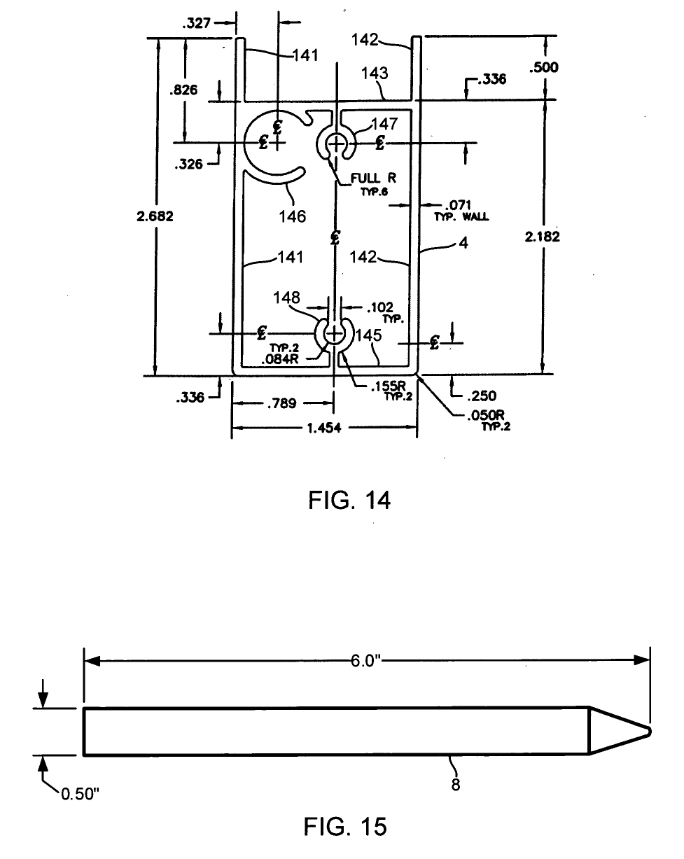

FIG. 4 shows details regarding how the locking rod 8 positioned in the bottom rail 4 is manipulated to engage the channel 7 in order to lock the storm shutter in the closed configuration. As described more fully below with reference to FIG. 14, the bottom rail 4 includes a locking rod boss 146 in which the locking rod 8 can slide in the horizontal direction. A locking rod opening 41 in the bottom rail 4 is machined in order to permit the thumbscrew 17 to pass. The locking rod opening 41 is elongated to accommodate the full travel of the locking rod 8 between the engaged and disengaged positions.

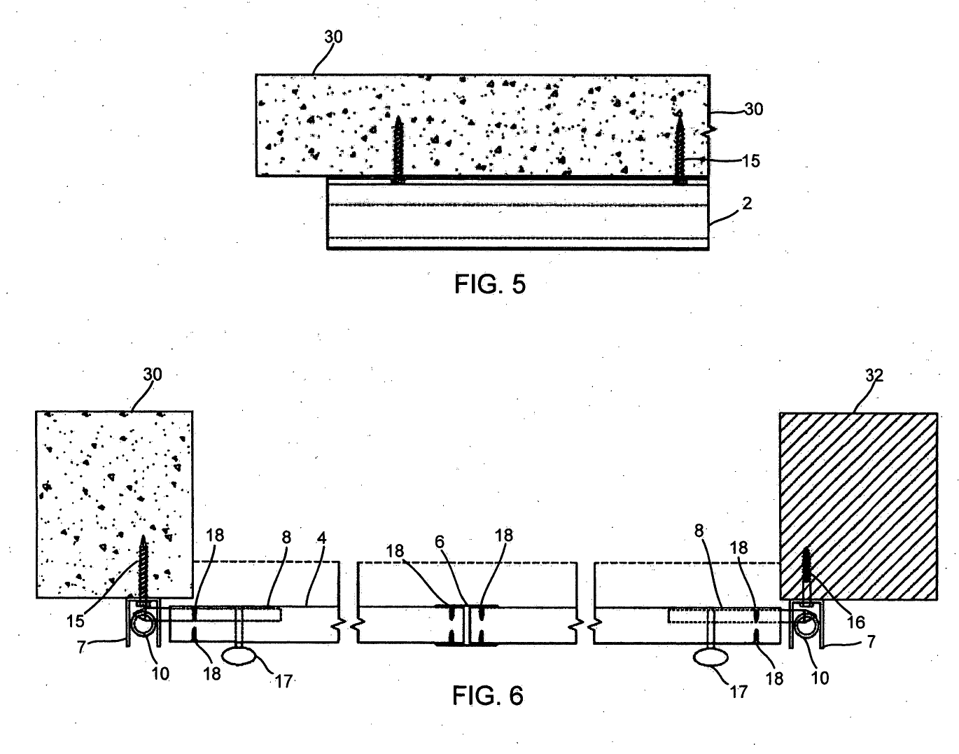

FIG. 5 shows a cross-section of the female hinge 2 at a point of connection to a building 30. As mentioned above, the female hinge 2 is attached to structures such as by lag screws or masonry anchors such as tapcons® 15. The lag screws or tapcons® 15 maybe attached to the building he approximately every 12 inches.

FIG. 6 shows a cross-section of the bottom portion of the storm shutter showing additional design elements. FIG. 6 shows how the thumbscrew 17 can be threaded through the bottom rail 4 to engage the locking rod 8. By tightening the thumbscrew 17, the locking rod 8 can be held in place, either in the engage position as illustrated in FIG. 6, or in the retracted position for opening the storm shutter. Threaded fasteners, such as machine screws 18 can be used to a fix structures such as the center mullion 6 to the bottom rail 4.

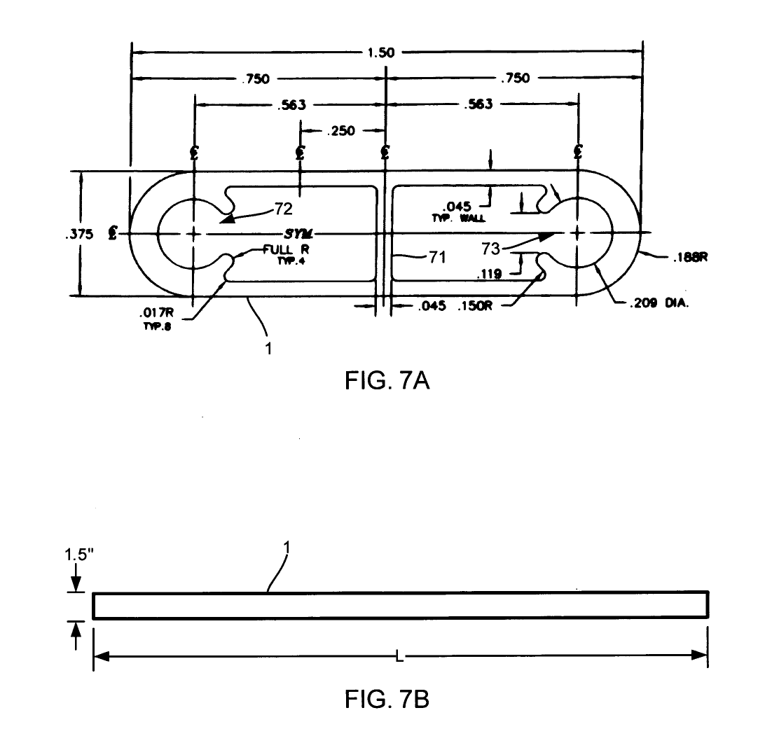

FIG. 7A is a cross-sectional view of a shutter blade 1, while FIG. 7B shows a top view of a blade. In the embodiment illustrated in FIG. 7A, the shutter blade 1 is an extruded aluminum beam having parallel top and bottom surfaces separated by a perpendicular rib 71 with semicircular closed ends forming a hollow interior. This structure has the bending resistance of an I-beam, and thus has high impact resistance for its weight. The semicircular closed ends can be formed as two screw bosses 72, 73 into which machine screws could, optionally, be threaded at the ends, such as to attach the shutter blades 1 to side rails 5 as provided in an optional embodiment. FIG. 7B shows a top view of the shutter blade 1 showing its overall configuration. In a preferred embodiment, the shutter blade is approximately 1.5 inches in width and approximately 0.375 inch, while the length “L” depends upon the width of the opening or window being covered by the storm shutter. For example, for a strong shutter with an overall with of approximately 50 inches, the shutter blade 1 may have a length L of between about 48 and about 49.8 inches. Dimensions of a preferred embodiment of the shutter blade 1 are illustrated in FIG. 7A.

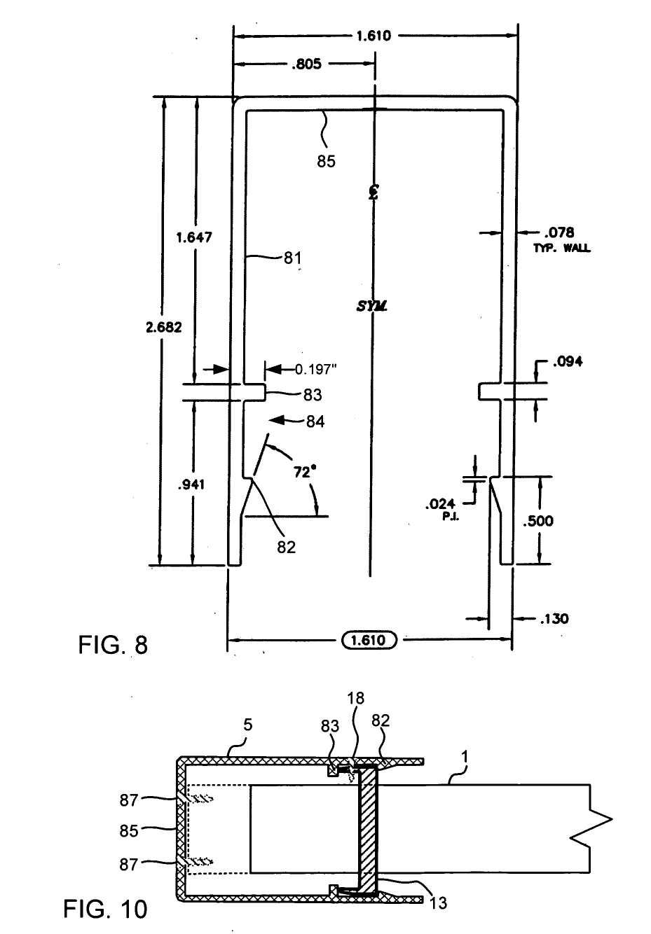

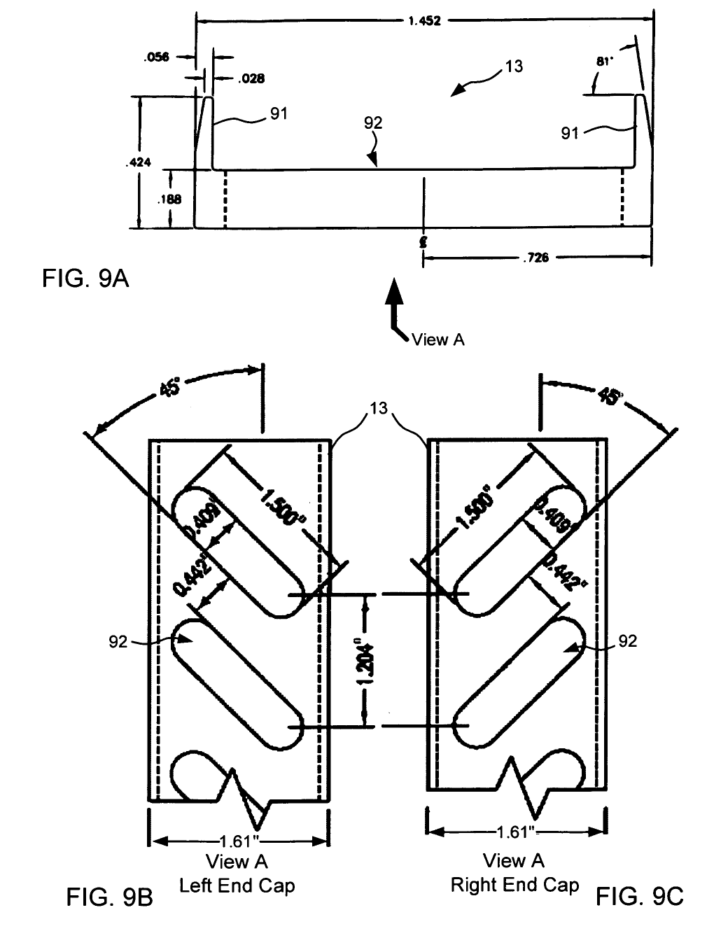

FIG. 8 is a cross-sectional view of the side rail 5. The side rail 5 is preferably an extruded aluminum beam with a wall thickness of approximately 0.078 inches in the form of an open box with interior steps 82 and ridges 83. More particularly, the side rail 5 includes side walls 81 and an outer wall 85. The space between the interior steps 82 and ridges 83 forms a groove 84 along the length of each side wall 81 into which the end cap 13 (shown in FIGS. 9A-9C) can fit. In a preferred embodiment, the groove 84 has a width of approximately 0.44 inches, which is just slightly larger than the 0.424 inch (approx.) width of the end cap 13 in a preferred embodiment. When the corner joints are assembled by slipping the side rail 5 over the top rail 3 and bottom rail 4 as described more fully below, machine screws can be threaded through holes drilled in the outer wall 85 and into screw bosses 128, 129, 147, 148 (shown in FIGS. 12 and 14). Dimensions of a preferred embodiment of the side rail 5 are illustrated in FIG. 8.

Details of the end cap 13 are shown in FIGS. 9A-9C. The end cap 13 includes diagonal extension portions 91 which extend from one side of the end cap 13. These diagonal extension portions 91 feature an exterior surface which is canted inward (i.e., toward the centerline). As discussed below with reference to FIG. 10, the diagonal extension portions 91 are configured to engage the step 82 and the side rail 4 in order to press apart the side walls 81 when the end cap 13 is pressed into the side rail 4. The end cap 13 provides the main support for the ends of the shutter blades 1. The end cap 13 is provided with a thickness sufficient to support the loads applied by the shutter blades 1, such as a thickness of approximately 0.188 inches in the preferred embodiment. In a preferred embodiment the end cap is extruded aluminum. To support each shutter blade 1, slots 92 are machined into the end cap 13 with dimensions closely matching those of the blades. For example, in the embodiment illustrated in FIGS. 9A-9C, the slots 92 have a long axis dimension of approximately 1.5 inches that matches the width of the shutter blade 1 shown in FIG. 7A, and a short axis dimension of approximately 0.409 inch which is slightly wider than the 0.375 inch thickness of the shutter blade 1 shown in FIG. 7A. As these figures illustrate, the slots 92 in the end caps 13 define the angle at which the shutter blades 1 are canted, which is 45° in the illustrated embodiment. Also, FIGS. 9B and 9C show how the end caps 13 are provided in two varieties, namely a left hand end cap as illustrated in FIG. 9B and a right-hand end cap as illustrated in FIG. 9C. Dimensions of a preferred embodiment of the end caps 13 are illustrated in FIGS. 9A-9C.

As illustrated in FIG. 10, either end of the shutter blades 1 (which are illustrated in FIGS. 7A and 7B) fit through an end cap 13 (illustrated in FIGS. 9A-9C) within each of the side rails 5, with the shutter blades 1 extending horizontally between the two side rails 5. The shutter blades 1 are held in place by fitting closely within slots 92 in an end cap 13 which is snapped into a side rail 5. As FIG. 10 shows, the end cap 13 is held in place within the groove 84 formed between the ridge 83 and the step 82 in the walls 81 of the side rail 5. To snap the end cap 13 into the groove 84, the end cap 13 is pressed or tapped (e.g., with a mallet) into the open part of the side rail 5. This pressure causes the diagonal extensions 91 of the end cap 13 to press against the diagonal portion of the step 82 in the side rail 5, which causes the walls 81 of the side rail 5 to flex sufficient to allow the end cap 13 to slip into the groove 84. Once the end cap 13 is fully inserted into the groove 84, the walls 81 of the side rail 5 spring back to their original shape, thereby locking the end cap 13 in place. Optionally, the side wall 81 of the side rail 5 may be further attached to the end cap 13 by mechanical fasteners, such as sheet metal screws 18 threaded through the side wall 81 and into the diagonal extensions 91 in the end cap 13. As shown in FIG. 1, such additional fasteners may be positioned periodically along the length of the side rails 5. Mechanically attaching the side wall 81 to the end cap 13 in this manner helps to reduce flexure of the side rail 5 walls under wind and impact loads. Also optionally, shutter blades may additionally be attached the side rails 5 by mechanical fasteners (e.g., machine screws) threaded through the outer wall 85 of the side rail 5 and into the screw bosses 72, 73 in the shutter blades 1.

A key structural component of the Bahama-style storm shutter and design is the center mullion 6, details of which are illustrated in FIGS. 11A and 11B. As described above, the center mullion 6 is positioned approximately on the centerline of the storm shutter spanning the height between the bottom rail 4 and the top rail 3. As shown in FIG. 11A, the center mullion 6 has an I-beam configuration with a relatively thick central portion 110. This configuration gives the center mullion 6 increased structural strength. To accommodate the shutter blades 1, slots 111 matching the cross-sectional profile of the shutter blades 1 are machined into the center portion 110, as illustrated in FIG. 11B. In a preferred embodiment, the slots 111 are machined to match the profile dimensions of the shutter blades 1 closely enough so that so the slots 111 support the shutter blades 1 during storms but with enough tolerance to allow the shutter blades 1 to be easily slipped through the slots 111 during assembly. Closely matching the dimensions of the slots 111 to the cross-sectional profile of the shutter blade 1 also reduces rattling during high winds. As illustrated in FIG. 11B, the slots 111 are canted at an angle of about 45° to the vertical in a preferred embodiment, although the shutter blades may be chanted at any other angle. In a preferred embodiment, the center portion 110 of the center mullion 6 has a cross-section thickness of about 0.25 inches with sidewalls 112 of approximately 0.078 inches. Other approximate dimensions of the preferred embodiment are illustrated in FIGS. 11A and 11B. In an embodiment, the center mullion 6 is fabricated from aluminum, and in a preferred embodiment is extruded aluminum which is finish machined to create the slots 111.

FIG. 12 shows a cross-sectional view of the top rail 3 according to an embodiment. The top rail 3 provides the support structure for the storm shutter as it includes the male hinge element 124 which couples with the female hinge 2. The top rail 3 may be configured as a box structure having side walls 121, 122 and top and bottom walls 123, 125, with side wall extensions 126, 127 extending beyond the bottom wall 125. A male hinge portion 124 is coupled to a top corner of the top rail 3. Within the enclosed box structure are provided screw bosses 128, 129 coupled to the bottom and top walls 125, 123, respectively. Dimensions of a preferred embodiment of the top rail 3 are illustrated in FIG. 12.

FIG. 13 shows a cross-sectional view of the female hinge 2. This component includes the female hinge portion 131 which is supported by a cantilever portion 132 coupled to an attachment portion 133 which contacts the structure and through which attachment lag screws or tapcons® are threaded as illustrated in FIGS. 2, 3 and 5. Dimensions of a preferred embodiment of the female hinge 2 are illustrated in FIG. 13.

FIG. 14 shows a cross-sectional view of the bottom rail 4 according to an embodiment. The bottom rail 4 provides the locking support structure for the storm shutter as it includes the locking rod 8 which locks the storm shutter to the channel 7. The bottom rail 4 may be configured as a box structure having side walls 141, 142 and top and bottom walls 143, 145, with the side walls 141, 142 extending beyond the top wall 143. Within the enclosed box structure are provided screw bosses 128, 129 coupled to the bottom and top walls 125, 123, respectively. Also included within the box structure is the locking rod boss 146 in which the locking rod 8 slides. Dimensions of a preferred embodiment of the bottom rail 4 are illustrated in FIG. 14.

As mentioned above, the storm shutter is locked in the closed configuration by means of locking rods 8 positioned on either side of the bottom corners of the assembly. Details and dimensions of the locking rods 8 in a preferred embodiment are illustrated in FIG. 15. The locking rod 8 may be a simple cylindrical rod having an approximately pointed end. The locking rods 8 can be made of any strong material or metal, and in a preferred embodiment is made of aluminum.

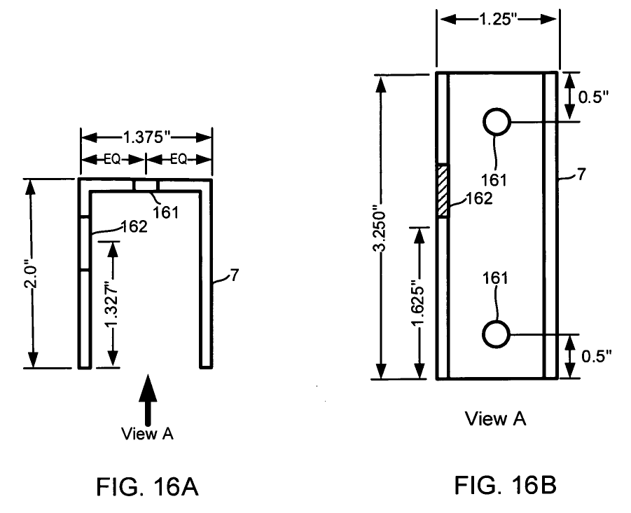

FIGS. 16A and 16B show top and side views of the channel 7 which is attached to the structure near the bottom corners of the storm shutter for receiving the locking bolt 8 when the shutter is in the closed configuration. The channel 7 may be a simple open ended box-shaped bracket including holes 161 in a back wall for screwing or bolting the channel to the structure and a hole in at least one side which is sized and positioned to receive the locking bolt 8. The channel 7 may be made out of aluminum. Approximate dimensions of the preferred embodiment channel 7 are illustrated in FIGS. 16A and 16B.

The various embodiments described above provide an exceptionally strong Bahama-style shutter design. Testing of a 50 inch by 96 inch preferred embodiment Bahama-style shutter design demonstrated resistance to positive/negative 55 pounds-per-square foot pressures without the need for any further reinforcing.

In addition to being strong, the Bahama-style shutter design according to the various embodiments is easily assembled. The following is an example of one of a variety of assembly methods that may be implemented to fabricate the Bahama-style storm shutter according to an embodiment. The bottom rail 4 is machined to provide the thumb screw opening 41 (shown in FIG. 4) in the front of the rail near both ends. A locking rod 8 is inserted into the locking rod boss 146 in each end with the pointed end facing outward, and a thumb screw 17 is threaded into the locking rod 8. Prior to attaching the top rail 3 and bottom rail 4 to the two side rails 5, the steps 82 and ridges 83 in the side rails 5 are milled out of the top and bottom ends to a depth approximately equal to the height of the top rail 3 and bottom rail 4, respectively, which in the preferred embodiment is to a depth of about 2.7 inches. This enables the side rails 5 to fit over the top rail 3 and bottom rail 4. Additionally, holes are drilled in the outer walls 85 of the side rails 5 so as to line up with the screw bosses 128 and 129 in the top rail 3 and the screw bosses 147, 148 in the bottom rail 4. So prepared, the corresponding (i.e., left or right) end cap 13 is tapped into place in the groove 84 within one side rail 5, and that side rail is slipped over one end of the top rail 3 and bottom rail 4. The side rail 5 is secured to the top rail 3 and bottom rail 4 by threading machine screws into the screw bosses 128 and 129 in the top rail 3 and the screw bosses 147, 148 in the bottom rail 4. Additional strength may be provided by also inserting a mechanical fastener, such as a machine screw 18, through the side wall 81 of the side rail 5 and into the top rail 3 and bottom rail 4 (as shown in FIG. 6). This mechanical fastener helps to keep the side walls 81 of the side rails 5 from flexing under load. The center portion 110 of the top and bottom ends of the center mullion 6 is milled out to a depth equal to the height of the top rail 3 and bottom rail 4, respectively, which in the preferred embodiment is to a depth of about 2.7 inches. So prepared, the center mullion 6 can be slipped over the top rail 3 and bottom rail 4 and secured in place by machine screws 18. FIG. 6 shows the machine screws 18 securing the center mullion 6 to the bottom rail 4. Note that the center mullion 6 may be positioned on the top rail 3 and bottom rail 4 prior to fastening the side rail 5. At this point the shutter blades 1 can be installed by slipping each through a slot 111 in the center mullion 6 and through a corresponding slot 92 in the end cap 13 in the side rail 5. An end cap corresponding (i.e., right or left) to the side rail 5 yet to be attached is slipped over the exposed end of the shutter blades 1. (Alternatively, the shutter blades 1 can be threaded through the second end cap 13 prior to being slipped through the center mullion 6). When all of the shutter blades 1 have been installed and the second end cap 13 is in place, the second side rail 5 can be attached. As with the first side rail 5, it is slipped over the top rail 3 and bottom rail 4 and secured by threading machine screws into the screw bosses 128 and 129 in the top rail 3 and the screw bosses 147, 148 in the bottom rail 4. Again, additional strength may be provided by also inserting a mechanical fastener, such as a sheet metal screw 18, through the side wall 81 of the side rail 5 and into the top rail 3 and bottom rail 4 (as shown in FIG. 6). Either prior to or after attaching the side rails 5 to the bottom rail 4, 0.5 inch (approx.) holes are drilled in the outer wall 85 of the side rails 5 positioned to align with the locking rod boss 146 in the bottom rail 4. The storm shutter then can be finished by sliding the female hinge 2 onto the male hinge portion of the top rail 3 and attaching the opening rods 9, 10 which are attached to the channel 7. At this point, the shutter panel 2 is ready for assembly on a structure. Shutter panels may be painted or coated with protective materials before or after assembly. This simple assembly process and reduced material count reduces the cost of manufacturing the storm shutters.

To install the Bahama-style shutter on buildings, contractors merely need to attach the female hinge 2 to the top of the opening frame in the structure such as by using lag screws 16 for wood frames or tapcons® 15 or other masonery anchors for brick and concrete block structures. Additionally, the channel 7 is attached to the frame near the bottom of the opening using lag screws 16 or tapcons® 15 as appropriate. This simple attachment process reduces the cost of installing the storm shutters.

To position the Bahama-style storm shutters in the closed configuration, the thumb screw 17 on the locking collar 12 is loosened to allow the top serrated tube 9 to slip into the bottom serrated tube 10 while lowering the shutter. When the shutter is in the closed position (i.e., vertical and adjoining the structure), the locking rods 8 are slide outward to engage the locking rod hole 162 in the channel. At this point the locking rods 8 are fixed in position by tightening the attached thumb screws 17. In some implementations, the locking rod thumb screws may be positioned on the inside of the shutter enabling the closing process to be completed from the inside. This simple deployment process allows home and business owners to deploy their storm shutters more quickly than is the case with conventional storm shutters, and thereby provide more time for them to evacuate if needed.

In a preferred embodiment all of the aluminum components (e.g., shutter blades 1, female hinge 2, top rail 3, bottom rail 4, side rails 5, center mullion 6, channel 7, locking rod 8, serrated tubes, 9, 10, locking collar 12 and end cap 13) can be made from Aluminum 6063-T5. However, other materials may be used, such as other aluminum alloys and higher strength materials as would be appreciated by one of skill in the art.

The foregoing description of the various embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, and instead the claims should be accorded the widest scope consistent with the principles and novel features disclosed herein.

I claim:

1. A Bahama-style storm shutter, comprising:
first and second side rails;
a top rail coupled to the first and the second side rails;
a bottom rail coupled to the first and second side rails;
a first end cap coupled to the first side rail, the first end cap including a plurality of slots;
a second end cap coupled to the second side rail, the second end cap including a plurality of slots;
a plurality of shutter blades each extending between the first end cap and the second end cap; and
a center mullion coupled to the top rail at a first end and to the bottom rail at a second end,
wherein:
at least one of the plurality of shutter blades is positioned within one of the plurality of slots in the first end cap, passes through one of the slots in the center mullion and is positioned within one of the plurality of slots in the second end cap.

2. The Bahama-style storm shutter of claim 1, wherein each one of the plurality of shutter blades is positioned within one of the plurality of slots in the first end cap, passes through one of the slots in the center mullion and is positioned within one of the plurality of slots in the second end cap.

3. The Bahama-style storm shutter of claim 1, wherein:
each of the first and second end caps has a thickness of about 0.188 inches; and
the center mullion has a center portion with a thickness of about 0.250 inches.

4. The Bahama-style storm shutter of claim 1, wherein each of the plurality of slots in the first and second end caps and the center mullion are canted at 45° to vertical.

5. The Bahama-style storm shutter of claim 1, wherein the plurality of shutter blades have a thickness of about 0.375 inches and width of about 1.5 inches.

6. The Bahama-style storm shutter of claim 1, wherein the first end cap is lodged in a gap within a wall of the side rail formed between a ridge and a step.

7. The Bahama-style storm shutter of claim 1, further comprising a locking bolt positioned within a locking bolt boss within the bottom rail, wherein the locking bolt is engaged in a hole in a channel coupled to a structure when the Bahama-style storm shutter is in a closed configuration.

8. The Bahama-style storm shutter of claim 1, wherein the slots in the center mullion are machined to a profile similar to a cross-section profile of the plurality of shutter blades.

9. A Bahama-style storm shutter, comprising:
a plurality of shutter blades each extending between the first end cap and the second end cap; and
a center mullion coupled to a top rail at a first end and to a bottom rail at a second end, the center mullion having a plurality of slots each configured to accept one of the plurality of shutter blades,
wherein each of the plurality of shutter blades passes through a respective one of the plurality of slots in the center mullion.

10. The Bahama-style storm shutter of claim 1, wherein the center mullion has a center portion with a thickness of about 0.250 inches.

11. The Bahama-style storm shutter of claim 1, wherein each of the plurality of slots in the center mullion are canted at 45° to vertical.
